(19) United States
(12) Patent Application Publication
(10) Pub. No.: US 2011/0276601 A1
(43) Pub. Date: Nov. 10, 2011

(54) KNOWLEDGE BASE COMPUTER MANAGEMENT NETWORK

(75) Inventors: Olivier Y. Pin, San Francisco, CA (US); Etienne Giraudy, San Francisco, CA (US); Orjan Kjellberg, Walnut Creek, CA (US); Mark A. Fischer, Ashland, OR (US)

(73) Assignee: salesforce.com, inc., San Francisco, CA (US)

(21) Appl. No.: 13/100,767

(22) Filed: May 4, 2011

Related U.S. Application Data
(60) Provisional application No. 61/331,300, filed on May 4, 2010.

(51) Int. Cl. G06F 17/30

(52) U.S. Cl. 707/783; 707/E17.005

(57) ABSTRACT

The present invention features a computer implemented method and network for managing a knowledge base stored in a multi-tenant architecture. The method includes storing information corresponding to a plurality of KnowledgeArticles amongst a plurality of tables. Information in a first of the plurality of tables includes data corresponding to an online version of said KnowledgeArticles and data related to changes to the KnowledgeArticles. Information contained in a second table comprises a subset of the data that is independent of the data related to the changes. Changes to the KnowledgeArticles are recorded in the second table in response to changes made to the first table. Access to information in the first table is restricted access to users having write access to said KnowledgeArticles.

### CROSS REFERENCE TO RELATED APPLICATIONS

The present application claims priority to U.S. provisional patent application No. 61/331,300 filed May 4, 2010, entitled APPLICATION PROGRAMMING INTERFACE FOR A MULTI-TENANT ON-DEMAND DATABASE and identifying Oliver Y. Pin, Etienne Girauday, Orjan Kjellberg and Mark A. Fischer as inventors. This aforementioned patent application is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to knowledge base management and generation and more particularly to techniques for computerized collection, organization, and retrieval of content accessed through a multi-tenant database.

The rate at which information is being generated is difficult to quantify. Two economists at the University of California at Berkeley Hal Varian and Peter Lyman estimated that the total production of new information in the year 2000 was approximately 1.5 exabytes or about 37,000 times as much information as is in the entire holdings Library of Congress. In the year 2003 it was determined that new information production was more than double the production of information in the year 2000. Managing this production of information has been a constant pursuit of society. As a result, many systems have been developed to organize information and provide searchable databases through which information may be accessed and used to address various situations. The internet may be considered one of these searchable databases.

However, due to the magnitude of disparate information available in the public domain, such as on the internet, only a very small percentage of the information is available due to the massive amounts of information through which one must peruse. The information is typically buried amongst articles contained in magazines, journals, papers, newspapers, books, notebooks and the like. Alternatively, the information is stored in digital format in information stores such as databases, digital libraries and the like. Unless otherwise stated, the term “article” as used in this application should be construed to include any transcribed or printed information, or information available in digital format, or combinations or portions thereof. The information in an article may include text, graphics, charts, audio information, video information, multimedia information, and other types of information in various formats. An article may be published or unpublished. Since these articles could number in the millions it is difficult for the same to be accessed, read, and understood in a reasonable time. Management of such a vast amount of information becomes more problematic when allowing creation and storage of information on a common database that is used to access the information.

There is a need, therefore, to provide techniques that facilitate accessing and generating content on a computer database that is accessible to multiple users over a computer network.

### BRIEF SUMMARY

The present invention features a computer implemented method and network for managing a knowledge base stored in a multi-tenant architecture. The method includes storing information corresponding to a plurality of KnowledgeArticles amongst a plurality of tables. Information in a first of the plurality of tables includes data corresponding to an online version of said KnowledgeArticles and data related to changes to the KnowledgeArticles. Information contained in a second table comprises a subset of the data that is independent of the data related to the changes. Changes to the KnowledgeArticles are recorded in the second table in response to changes made to the first table. Access to information in the first table is restricted access to users having write access to said KnowledgeArticles. These and other embodiments are discussed more fully below.

### BRIEF DESCRIPTION OF THE DRAWINGS

FIG. 1 is a simplified plan view of a computer network in which the current invention is practiced;

FIG. 2 is a plan view showing a representative architecture in which a multi-tenant database system, shown in FIG. 1, is employed;

FIG. 3 is a detailed view of a computer drive shown in FIG. 2 showing the arrangement of data stored thereon;

FIG. 4 is a detailed view of a hard drive shown in FIG. 2 demonstrating the various tables in which the present invention is stored;

FIG. 5 is a detailed view of a KnowledgeArticle table, shown in FIG. 4, in accordance with the present invention;

FIG. 6 is a detailed view of a KnowledgeArticleVersion table, shown in FIG. 4, in accordance with the present invention;

FIG. 7 is a detailed view of a KnowledgeArticleVersion_custom_data_table, shown in FIG. 4, in accordance with the present invention;

FIG. 8 is a plan view of a first web page of a user interface in accordance with the present invention;

FIG. 9 is a plan view of a second web page of the user interface shown in FIG. 8, in accordance with the present invention;

FIG. 10 is a plan view of a third web page of the user interface shown in FIG. 8, in accordance with the present invention;

FIG. 11 is a plan view of a fourth web page of the user interface shown in FIG. 8, in accordance with the present invention;

FIG. 12 is a plan view of a fifth web page of the user interface shown in FIG. 8, in accordance with the present invention;

FIG. 13 is a plan view of a sixth web page of the user interface shown in FIG. 8, in accordance with the present invention;

FIG. 14 is a plan view of a seventh web page of the user interface shown in FIG. 8, in accordance with the present invention; and

FIG. 15 is a plan view of an eighth web page of the user interface shown in FIG. 8, in accordance with the present invention.

### DETAILED DESCRIPTION OF THE INVENTION

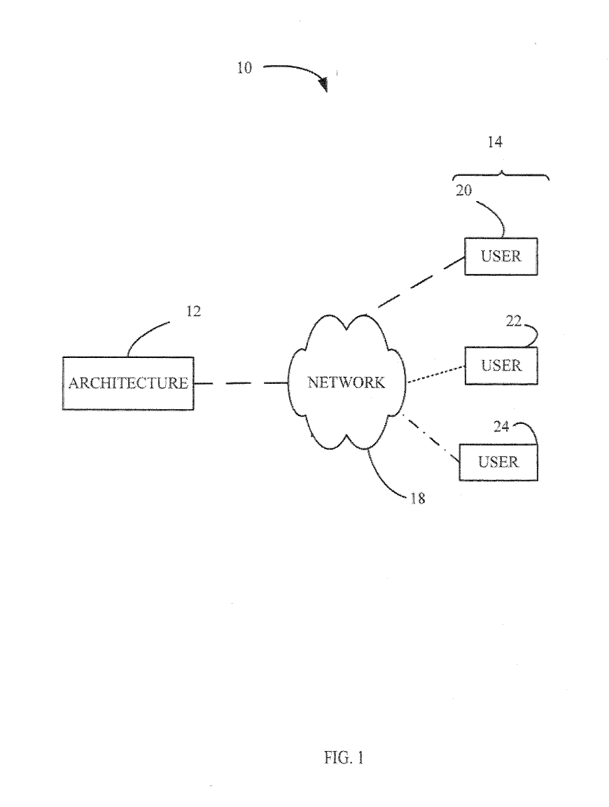

Referring to FIG. 1, a computer network 10 includes a multi-tenant database architecture 12 in data communication with client side facilities 14. Components of computer network 10 may be in data communication over any type of known data communication network 18 or combination of networks of devices that communicate with one another. Data communication network 18 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global inter-network of networks often referred to as the “Internet”, it will be used in many of the examples herein. However, it should be understood that the networks that the present invention might use are not so limited, although TCP/IP is a frequently implemented protocol. As a result the components of network 10 may be co-located in a common geographic area and/or building or spread across a diverse area of the globe, e.g., on several different continents. Typically, client side facilities 14 and STS 16 are in data communication with architecture 12 over the Internet using suitable computer systems. Architecture 12 includes a multi-tenant database system (MTS) in which various elements of hardware and software are shared by one or more multiple users 20, 22 and 24 associated with client side facilities 14.

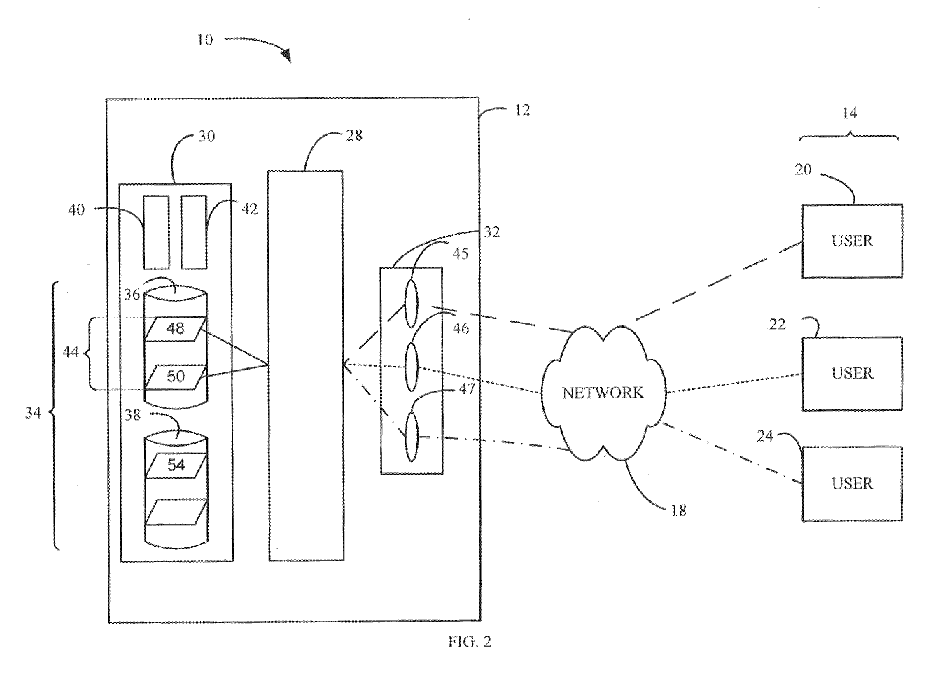

A given application server of MTS may simultaneously process requests for a great number of users, and a given database table may store rows for a potentially much greater number of users. To that end, and as shown in FIG. 2, architecture 12 includes a processor sub-system 28, memory space 30, in data communication therewith, and network interface resources 32 in data communication with both memory space 30 and processor sub-system 28. Processor sub-system 28 may be any known processor sub-system in the art, e.g., the CORE DUO® or the CORE 2 DUO® from Intel Corporation of Santa Clara, Calif. Memory space 30 includes drive storage 34, shown as one or more hard drives 36 and 38, as well as data and instruction registers, shown as 40, and volatile and non-volatile memory shown as 42.

Architecture 12 provides access to a database 44 by multiple users 20, 22 and 24 of client side facilities 14 over data communication network 18 using standard computer systems (not shown). To that end, network interface resources 32 include a plurality of virtual portals 45-47. Each virtual portal 45-47 provides an “instance” of a portal user interface coupled to allow access to database 44. Typically, tenants obtain rights to store information, referred to as tenant information 48 and 50, on database 44 and make the same accessible to one or more users 20, 22 and 24 to whom the tenant provides authorization. This is typically achieved by rental agreements between the tenant and an owner/provider of architecture 12. In this manner, architecture 12 provides an on-demand database service to users 20, 22 and 24 that is not necessarily concerned with building and/or maintaining the database system; rather, these functions are addressed between the tenant and the owner/provider.

With architecture 12, multiple users 20, 22 and 24 may access database 44 through a common network address, in this example a universal resource locator (URL). In response, webpages and other content may be provided to users 20, 22 and 24 over data communication network 18. The resources of database 44 that users 20, 22 and 24 may access can be different, depending on user's 20, 22 and 24 security or permission level and/or tenant association. As a result, data structures included in tenant information 48 and 50 are managed so as to be allocated at the tenant level, while other data structures might be managed at the user level. Because architecture 12 supports multiple tenants including possible competitors, security protocols 52 and other system software 54, stored for example on hard drive 38, maintain applications and applications' use to only those users 20, 22 and 24 with proper access rights. Also, because many tenants may desire access to architecture 12 rather than maintain their own system, redundancy, up-time, and backup are additional functions that may be implemented in architecture 12.

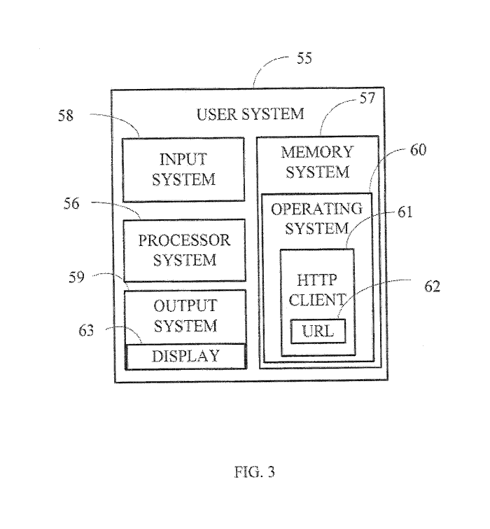

Referring to both FIGS. 2 and 3, to facilitate web-based public knowledge base, a user system 55 is employed by one of users 20, 22 and 24 to communicate with architecture 12 using TCP/IP and, at a higher network level, use other common Internet protocols to communicate, such as HTTP, FTP, AFS, WAP, etc. To that end, user system 55 may be any computing device capable of interfacing directly or indirectly to the Internet or other network connection, such as desktop personal computer, workstation, laptop, PDA, cell phone, or any wireless access protocol (WAP) enabled device and the like running an HTTP client. An example of a user system 55 includes a processor system 56, a memory system 57, an input system 58, and output system 59. Processor system 56 may be any combination of one or more processors, as discussed above with respect to architecture 12. Memory system 57 may be any combination of one or more memory devices, volatile, and/or non-volatile memory. A portion of memory system 57 is used to run operating system 60 in which an HTTP client 61 executes. Input system 58 may be any combination of input devices, such as one or more keyboards, mice, trackballs, scanners, cameras, and/or interfaces to networks. Output system 59 may be any combination of output devices, such as one or more displays 63, printers, and/or interfaces to networks. HTTP client 61 allows users 20, 22 and 24 of user system 55 to access, process and view information, pages and applications available to it from server system architecture 12 over network 18. Examples of HTTP client 61 include various browsing applications, such as Microsoft's Internet Explorer browser, Netscape's Navigator browser, Opera's browser, or a WAP-enabled browser in the case of a cell phone, PDA or other wireless device, or the like. Access is gained to requisite tenant information 48 and 50 by entering the URL (not shown) into the URL box 62 of HTTP client 61. The URL directs users 20, 22 and 24 to the appropriate virtual portal to determine authorization and permission level to access the requisite tenant information 48 and 50.

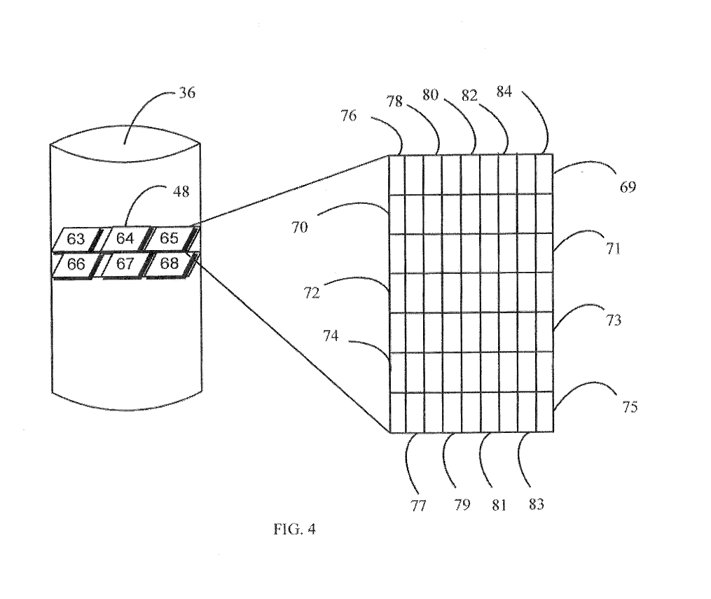

Referring to both FIGS. 2 and 4, it is desired to provide users 20, 22 and 24 with a public knowledge base in which articles may be generated, edited and eventually published in one or more different languages so as to provide a searchable database of a plurality of articles, potentially in the tens of thousands, if not millions that may be rendered on a user's display in a customizable interface. To that end, information concerning the articles is stored among tenant information 48 and 50 on database 44 to provide a public KnowledgeBase. The information is stored as a collection of objects, such as a set 63-68 of logical tables, containing data fitted into predefined categories. This is shown as rows, referred to as data objects 69-75 and columns 76-84 with respect to table 65. A “table” is one representation of a data object, and may be used herein to simplify the conceptual description of objects and custom objects according to the present invention. It should be understood that “table” and “object” may be used interchangeably herein.

Referring to both FIGS. 4 and 5, data related to the articles are stored amongst two tables, 63 and 64, KnowledgeArticle table (KAT) 63 and KnowledgeArticleVersion table (KAV) 64, with the information for the actual articles being stored in files (not shown) on database 44 contained in tenant information 48 and 50. KAT 63 includes a plurality of columns: an organization_id, ORG. ID., column 85; an article_id, ART. ID, column 86; a key_prefix, KEY, column 87; a delete status, DELETE, column 88, a has_archived status, ARCH., column 89; has online status, ONLINE, column 90, a has_draft status, DRAFT, column 91, a master_launguage, LANG, column 92; a denormalized, or custom, title column <system_modstamp+other information, MISC, column 93; a url_name, URL, column 94 and a title column 95. ORG. ID. column 85 identifies the tenant, or organization, with which the corresponding knowledge articles are associated.

The ART. ID. column 86 is a standard identification for the knowledge article associated with the information. The key_prefix column 87 is a unique identifier for the row entry in KAT 63. Columns 88-91 identify the status of the KAT as either being deleted, archived, draft, or online. Each of these states may be mutually exclusive and are identified by the presence of a flag that are maintained in Procedure Language/Structured Query Language. An archived KnowledgeArticle is one that is not deleted, or has neither an online or draft status associated therewith. The online status indicates that a KnowledgeArticle is published as part of a public KnowledgeBase and is accessible by users thereof having appropriate access. A draft KAT is one that has not an online status and is currently accessible to a limited number of users of architecture 12 having rights to modify and/or generate KnowledgeArticles. Master_language column 92 includes information identifying the original language in which the knowledge article associated therewith was drafted. A KnowledgeArticle may be generated in virtually any known language, e.g., English, German, Chinese, machine and the like. The information in Master_language column 89 is also present in the row of the KAV 64 corresponding thereto.

The URL column 94 identifies the link through which the KAT associated therewith can be accessed, typically having 255 characters maximum. It typically consists of a name that is unique, i.e., no two columns in KAT 63 will have the same URL. This means that the same KnowledgeArticles may have different addresses each associated with a different translation. It is desired to avoid having a dead link, one through which the KAT cannot be accessed. This may arise, for example, were a KAT deleted. This is avoided by providing a servlet to parse information in URL column 94 that identifies an assigned renderer, discussed more fully below, by article type, lookup the right KAV id, and then forward dispatch with rewritten URL. For example: http://<server:port>/knowledge/FAQ/FAQ_for_NokiaPhones. The “/FAQ” provides the article type, and a renderer is identified based on that information. Database 44 is accessed to identify the renderer as a function of subtype, as well as to get the right KnowledgeArticleVersion id from UrlName+additional context, e.g., status language and the like.

MISC column 99 includes information readily understandable and typically only meaningful to a user. URL column 94 includes information from an alternate identifier of the KAT that is typically only meaningful to the user. Custom title column 95 may include information related to a secondary or nickname of the knowledge article associated therewith.

The user document definition of KAT 63 is as follows.

<entity name=“KAT” isTemplate=“true” keyPrefix=“kA0” owner=“mfischer”
minApiVersion=“160”

orgAccess=“OrgPermissions.Knowledge” editAccess=“always”

apiAccess=“isDevInternal”

dbSchemaName=“knowledge” dbTableName=“article”
lockCorrectly=“yes” callPlsqlForNew=“no” isBulkDeleteable=“yes”

hasEntityObjectClass=“no”

isDeleteableViaEntityObject=“true” isApiUndeleteable=“yes” isPhysicalDeleted=“yes”
javaPackageRoot=“knowledge.article.entity” shortPlsqlName=“Article”

plsqlPackage=“kArticle”

motifName=“Knowledge” jspDetailPage=“ArticleRenderer” jspEditPage=“ArticleEdit”>

<field name=“IsDeleted” fieldType=“DELETEDFLAG”/>
<field name=“HasDraftVersion” columnType=“BOOLEAN” saveNormallyToDb=“no”/>
<field name=“HasOnlineVersion” columnType=“BOOLEAN” saveNormallyToDb=“no”/>
<field name=“HasArchivedVersion” columnType=“BOOLEAN” saveNormallyToDb=“no”/>
<field name=“CreatedDate” fieldType=“CREATEDDATE” insertNormallyToDb=“yes”

orgCreateAccess=“OrgPermissions.CreateAuditFields”
createAccess=“userHasCreateAuditFields”/>

<field name=“CreatedBy” fieldType=“CREATEDBY” insertNormallyToDb=“yes”

orgCreateAccess=“OrgPermissions.CreateAuditFields”
createAccess=“userHasCreateAuditFieids”/>

<field name=“LastModifiedDate” fieldType=“LASTUPDATE” insertNormallyToDb=“yes”

orgCreateAccess=“OrgPermissions.CreateAuditFields”
createAccess=“userHasCreateAuditFields”/>

<field name=“LastModifiedBy” fieldType=“LASTUPDATEBY” insertNormallyToDb=“yes”

orgCreateAccess=“OrgPermissions.CreateAuditFields”
createAccess=“userHasCreateAuditFields”/>

<field name=“SystemModstamp” fieldType=“SYSMODSTAMP”/>
<field name=“MasterLanguage” columnType=“STATICENUM” enum=“Language”

dbValueRequired=“yes” usesFieldSecurity=“false”/>

<field name=“Title” fieldType=“NAME” columnType=“TEXT” maxLength=“255”

searchNameLookupNameTypes=“Name” nameDenormColumns=“TextName”/><!--

<field name=“UrlName” columnType=“TEXT” maxLength=“255” dbValueRequired=“yes”

nameDenormColunms=“DeveloperName”/>

<field name=“UrlNameNorm” columnType=“TEXT” maxLength=“510”

dbValueRequired=“yes”

hasDefault=“yes” readNormallyFromDb=“no” apiDescribeVisible=“no”/>

<field name=“ArchivedDate” columnType=“DATEONLY”/>
<field name=“ArchivedBy” fieldType=“FOREIGNKEY” domain=“User”

dbColumnName=“archived_by” hasOracleIndex=“no”/>
</entity>

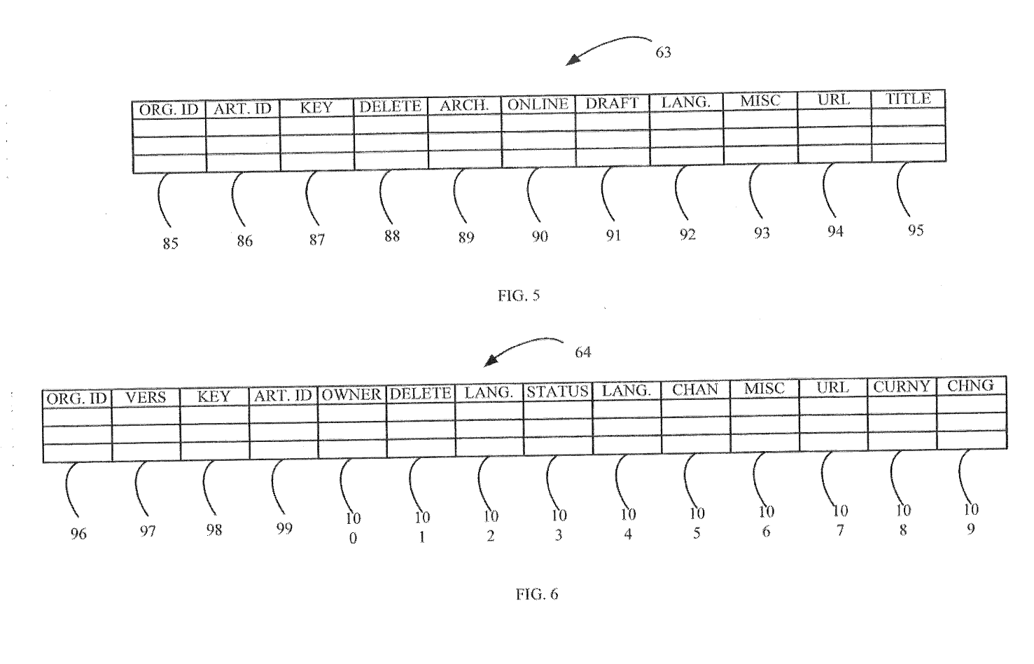

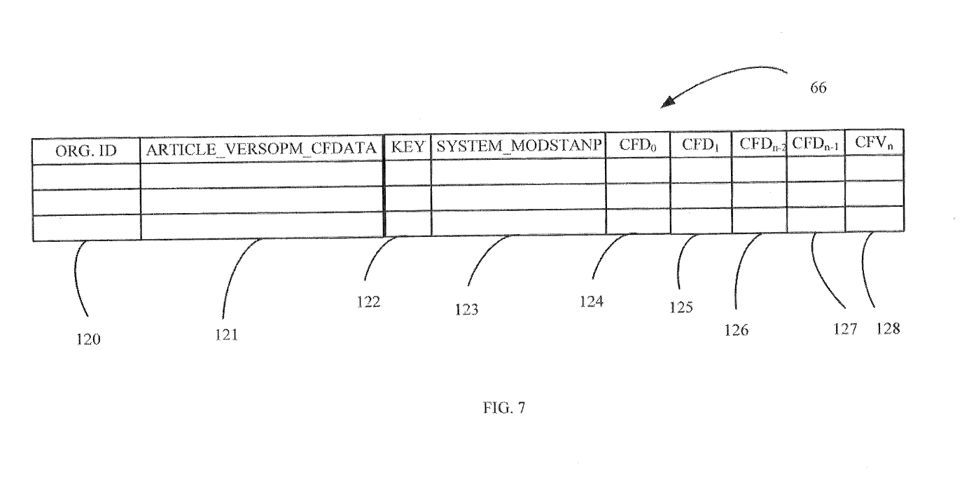

Referring to both FIGS. 4 and 6, detailed information concerning each knowledge article is stored in KnowledgeArticle Version (KAV) table 64. To that end, KAV 64 includes a plurality of rows, each of which is associated with a different knowledge article and/or version of a knowledge article. Each row has multiple columns associated therewith. These columns include organization_id, ORG. ID., column 96, article_version_id, VERS., column 97; key_prefix, KEY, column 98; article_id, ART. ID., column 99; owner information, OWNER, column 100, deleted, DELETE, column 101, is_master_language, LANG., column 102, publish_status, STATUS, column 103, language, column 104, channels column, 105, <system_modstamp>, MISC column 106, url_name, URL, column 107, currency_iso_code, CURNCY, column 108, reason_for_change, CHANGE, column 109. Columns 85, 87, 86, 88, and 92 contain the same data as columns 96, 98, 99, 101 and 102, respectively. VERS column 97 includes information concerning the version of the KnowledgeArticle corresponding to the row. It is submitted that multiple versions of an article may be present in database 44. Specifically, there may exist multiple versions of a common KnowledgeArticle with the understanding that each version corresponds to a different language. With respect to each version, there may be only one of a draft status or an online status, with the understanding that the KnowledgeArticle with the draft status has the most current information associated therewith, i.e., as compared to the corresponding KnowledgeArticle having the archived status. The status information is included in STATUS column 103. OWNER column 100 identifies the user 20, 22 or 24 that is responsible for the content of the KnowledgeArticle. Typically this is the user 20, 22 or 24 that created and/or published the KnowledgeArticle. CURNY column 108 includes information concerning the monetary units associated with the KnowledgeArticle. CHAN column 105 includes information concerning the channels through which a given KnowledgeArticle is available. Each channel corresponds to a pre-selected group of users 20, 22 and 24 that may access database 44 independent of security protocols that allow access to KnowledgeArticles through portals 45, 46 and 47. For example, Knowledge Article may be available through one or more of portals 45, 46, and 47 using standard security protocols. Alternatively, Knowledge Articles may be available only internally by users of owner of architecture 12, these KnowledgeArticles may not be accessible over a WAN, such as the Internet. Other KnowledgeArticles may be available to any users, i.e., without any authentication in a manner similar to public websites. Each one of the aforementioned different access paths, i.e., external with security, internal only access and external access without authentication is referred to as a channel. Any one of the aforementioned channels may be subdivided into additional channels. CHNG column 109 includes a code that corresponds to reasons for change of the KnowledgeArticle. For example, change could be necessitated by a publisher, the parties that are the subject of the KnowledgeArticle, a change to the product and/or services that are the subject of the KnowledgeArticle, a periodic/seasonal update of the KnowledgeArticle and the like.

The user document definition of KAV 64 is as follows.

<entity name=“KnowledgeArticleVersion” isTemplate=“true” keyPrefix=“ka0”
owner=“mfischer” minApiVersion=“160”

orgAccess=“OrgPermissions.Knowledge” edit Access=“always”

apiAccess=“isDevInternal”

dbSchemaName=“knowledge” dbTableName=“article_version”
usesFieldSecurity=“yes” emptyKeyPerOrg=“yes” customizable=“true”
lockCorrectly=“yes” callPlsqlForNew=“no” isBulkDeleteable=“yes”
isDeleteableViaEntityObject=“true” isApiUndeleteable=“yes” isPhysicalDeleted=“yes”
javaPackageRoot=“knowledge.article.entity” plsqlPackage=“kArticleVersion”
isApexTriggerable=“false” canBeForeignKeyTarget=“false” hasAttachments=“no”

hasActivities=“no”

isWorkflowEnabled=“true”
motifName=“Knowledge” jspDetailPage=“ArticleRenderer” jspEditPage=“ArticleEdit”>
<field name=“Id” fieldType=“PRIMARYKEY” dbColumnName=“article_version_id”/>

<field name=“KnowledgeArticle” fieldType=“FOREIGNKEY” domain=“KAT”

supportsParentLocking=“yes”

dbValueRequired=“yes” updateNormallyToDb=“no” alternateKeyIndex=“0”

dbColumnName=“article_id”/>

<field name=“Owner” fieldType=“OWNER” orgAccess=“OrgPermissionsMultiUser”

dbColumnName=“owner” allowsChangeOwner=“yes”/>

<field name=“IsDeleted” fieldType=“DELETEDFLAG”/>
<field name=“PublishStatus” columnType=“STATICENUM”

enum=“KnowledgePublishStatus” dbValueRequired=“yes”/>

<field name=“VersionNumber” columnType=“DOUBLE” scale=“2” dbValueRequired=“yes”

alternateKeyIndex=“1”/>

<field name=“Channels” columnType=“BITVECTOR”

bitVectorType=“KnowledgeChannels”/>

<field name=“CreatedDate” fieldType=“CREATEDDATE” insertNormallyToDb=“yes”

orgCreateAccess=“OrgPermissions.CreateAuditFields”
createAccess=“userHasCreateAuditFields”/>

<field name=“CreatedBy” fieldType=“CREATEDBY” insertNormallyToDb=“yes”

orgCreateAccess=“OrgPermissions.CreateAuditFields”
createAccess=“userHasCreateAuditFields”/>

<field name=“LastModifiedDate” fieldType=“LASTUPDATE” insertNormallyToDb=“yes”

orgCreateAccess=“OrgPermissions.CreateAuditFields”
createAccess=“userHasCreateAuditFields”/>

<field name=“LastModifiedBy” fieldType=“LASTUPDATEBY” insertNormallyToDb=“yes”

orgCreateAccess=“OrgPermissions.CreateAuditFields”
createAccess=“userHasCreateAuditFields”/>

<field name=“SystemModstamp” fieldType=“SYSMODSTAMP”/>
<field name=“IsMasterLanguage” columnType=“BOOLEAN”/>
<field name=“Language” columnType=“STATICENUM” enum=“Language”

dbValueRequired=“yes” alternateKeyIndex=“2” usesFieldSecurity=“false”/>

<field name=“Title” fieldType=“NAME” columnType=“TEXT” maxLength=“255”

searchNameLookupNameTypes=“Name” nameDenormColumns=“TextName”/><!--

<field name=“CurrencyIsoCode” fieldType=“CURRENCYCODE” hasUpdateDefault=“yes”/>
<field name=“ArchivedDate”columnType=“DATEONLY”usesFieldSecurity=“false”/>
<field name=“ArchivedBy” fieldType=“FOREIGNKEY” domain=“User”

dbColumnName=“archived by” usesFieldSecurity=“false”/>

<field name=“ReasonForChange” columnType=“TEXT” maxLength=“1000”/>

</entity>

KnowledgeArticle entries in KAV 64 may be categorized in a hierarchy. For example, were one KAT concerning a product, a second KnowledgeArticle may relate to details of a function provided by the product and thus would be sub-typed so as to be related to the original KnowledgeArticle. These concrete subtypes are defined by the tenant and/or owner of the KnowledgeArticle. This information along with metadata is stored in core.custom_entity_definition with a special bit set to identify them as article types. Other categories of sub-typed articles may include a KnowledgeArticle on frequently asked questions (FAQs), a KnowledgeArticle on offers, promotions and the like.

Referring to FIGS. 4 and 7, each sub-type of a KnowledgeArticle may have a set of custom fields that contain information unique to KnowledgeArticles of the subtype. To that end, database 44 may include multiple tables, one of which is discussed with respect to table 66 that include custom field data (cfd) for a particular article subtype: KNOWLEDGE.ARTICLE_VERSION_CFDATA table. Usually each custom field is associated with a common KnowledgeArticle subtype that differs from the custom field table 66 associated with the remaining subtype of KnowledgeArticles. Table 66 includes a plurality of columns 120-128. Columns 120 and 122 contain the same information as columns 96 and 98. Column. 121 contains article_version_cfdata_id that is the version of the KnowledgeArticle corresponding to the custom data. Columns 124-128 contains the custom field data and column 123, system_modstamp contains, the date and time KnowledgeArticle was created. Each KnowledgeArticle sub-type is associated with a pair of SObjects and is named so as to clearly indicate the subtype to which the SObjects apply, e.g., for the FAQ subtype one object could be named FAQ_h corresponding to the KAT table 63 and FAQ_k, corresponding to the KAV 64, wherein the latter SObject may be operated on by VISUALFORCE. VISUALFORCE is a component-based user interface framework available from the assignee of the present invention that includes a tag-based markup language, similar to HTML. Each Visualforce tag corresponds to a coarse or fine-grained user interface component, such as a section of a page, or a field. In this fashion, each KnowledgeArticle corresponding to a row in the KAV 64 may be supported by a custom renderer, user interface, discussed more fully below. For all columns not relevant to a KnowledgeArticle, an api variable is set as follows. apiDescribeVisible=“false”. For example:

<apex:page standardController=“Offer_k”>

<apex:outputField value=“Offer_k.Title”/>
<apex:outputField value=“Offer_k.Details_c”/>
<apex:outputField value=“Offer_k.TermsAndConditions_c”/>
<apex:outputField value=“Offer_k.FinePrint_c”/>

</apex:page>

It should be noted that the SObjects visible to VISUALFORCE may not necessarily be exposed to a public Application Programming Interface (API), such as APEX, which is available from the assignee of the current invention. To that end, the SObjects are established to be read-only and a recursive least squares (RLS) file is applied showing KnowledgeArticles having an online status, applying the RLS filter to only show online articles in the user's desired language while hiding remaining fields, as desired. To that end, not all information contained in tables 63, 64 and 64 is available to every user 20, 22 and 24 that may view KnowledgeArticles. Rather, the level of access to information contained in tables 63, 64 and 65 is dependent upon whether the user 20, 22 and 24 has publication authority, as well as the type of publication authority.

A publisher is a user 20, 22 and 24 that may create the initial draft version of a KnowledgeArticle, referred to as an Initial KnowledgeArticle (IKA). The commands to create a new KnowledgeArticle operate only on the KAV 64, Offer_kav, not KnowledgeArticle 63, Offer_ka. Restricting publisher status is tied to the security filters when the user 20, 22 and 24 accesses database 44. Offer_kav.Parent field has is ApiInsertable=“false”, and the Offer_ka is auto-created then set Offer_kav.Parent=Offer_ka.Id internally.

Typically the tenant with which the publisher is associated has a default language in which all KnowledgeArticles are drafted. However, a publisher may change the language so that a KnowledgeArticle is not necessarily the tenant's default language. A tenant may restrict this freedom and require all KnowledgeArticles be published in a default language. The row in KAT 63 and KAV 64 corresponding to an IKA is referred to as a “master version row”. Modifications of the IKA are saved as new versions, i.e., an additional row of information in KAT 63 and KAV 64 is generated which is identical to information in the master_row, excepting the status and the version information reflects the modifications. However, there exists modifications of a KnowledgeArticle that do not warrant generating a new row of information in KAT 63 or KAV 64 corresponding to a new version. For example were changes to a KnowledgeArticle such that changes to syntax and spelling were effectuated white leaving the overall content static. The publish may opt not to create a new version. Rather, the publisher may generate a draft from an existing version that is online and maintains the exact same version number. Once modifications have been effectuated and the same associated with a published status, the publisher may have the KnowledgeArticle, formerly having a draft status, replace the KnowledgeArticle formerly having an online status. No archiving of the KnowledgeArticle formerly having an online status occurs, because the two KnowledgeArticles correspond to a common version number. Thus, the KnowledgeArticle formerly having an online status is deleted. To create a new draft version as copy of an OKA, a PROCESS verb is employed. Were database 44 not to contain an OKA, an error would occur and be communicated to the publisher. For Offer_kav.PublishStatus field is read-only in the public API.

Translations of a KnowledgeArticle, referred to as a translated KnowledgeArticle (TKA) from the language identified in the master-version row may be generated at some point during or after the publication process, perhaps even after the is online. The master-row of KAV 64 is related to the row in the KAV 64 corresponding to the TKA by virtue of sharing a common VersionNumber and PublishStatus. Thus, were the OKA the subject of one or more TKA, which was also published, i.e., online, the deletion of the OKA deletes all corresponding TKAs. For example, the OKA may have been published in several different languages providing multiple TKAs. It should be understood, however, that a draft TKA can be related to only one of a draft master KnowledgeArticle or an online KnowledgeArticle, but not both.

Other users 20, 22 and 24, in addition to the publisher, are authorized to translate KnowledgeArticle into specific languages and are referred to as translators. Access granted to translators may be restricted in virtually any manner conceivable, dependent upon workflow rules. For example, a translator may be provided access to only certain sub-types of KnowledgeArticle, or KnowledgeArticles that have been published for a predetermined amount of time or KnowledgeArticle published in a certain geographic area, or a combination of the foregoing and the like.

Referring to FIGS. 2 and 6, to generate a TKA, of an existing KnowledgeArticle, either an IKA or another TKA, which may have an online status associated therewith, referred to herein as an Online KnowledgeArticle (OKA), a translator generates a new draft, that is a copy/clone of OKA. This generates a row of information in KAV 64 referred to as a translation row. The information in the translation_row is substantially similar to the information in the master_row, excepting that the translation row indicates that the status in column 103 is indicated as being draft and the language information in column 104 identifies the language of the current draft. The version information in column 97 is the same between both master_row and translation_row, as should be the information in the remaining columns. Once the TKA is associated with an online status, the rows corresponding to the OKA are deleted, updating the information in status column 103 for the transtation_row to online. Deletion occurs upon changing the status in column 103 of the translation_row, because the version information in column 97 is the same in both the translation_row and the master_row. Were the version information different, the change of status of the translation_row would result in a change of status of the master_row_from online to archived. In other words, the OKA corresponding to the master_row is not deleted, but merely archived on database, i.e., the information corresponding thereto is preserved.

Typically users 20, 22 and 24 accessing database 44 are able to read KnowledgeArticles that are in an online status and in a default language that is associated with the user 20, 22 and 24. If no online version of a KnowledgeArticle exists in the language associated with the user 20, 22 and 24 requesting access to database 44, then the user 20, 22 and 24 would not perceive the KnowledgeArticle: User 20, 22 and 24 would not know that the KnowledgeArticle existed. This level of access to KnowledgeArticles is in addition to the security access filtering discussed above and typically is not enforced at that level. As a result, restricting users 20, 22 and 24 to access KnowledgeArticles based upon a pre-authorize language is not a real security filter. Typically, only a single row of information in KAV 64 corresponding to the KnowledgeArticle requested is provided to a user 20, 22 and 24 and it is the row that best fits the overall language preferences of the user 20, 22 and 24.

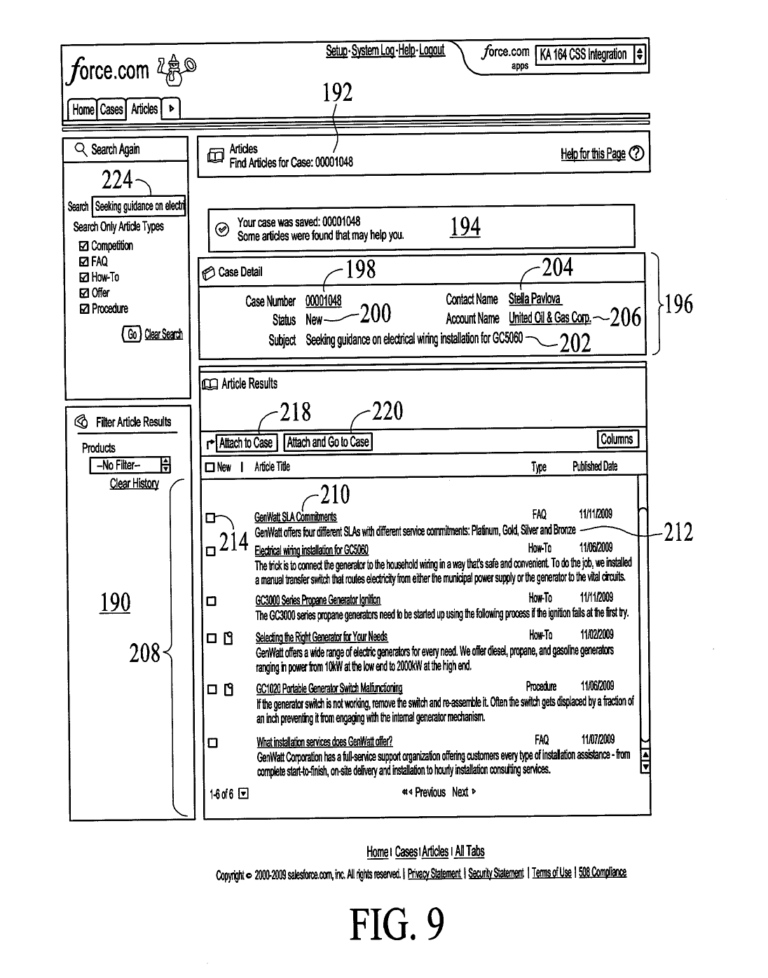

Referring to FIGS. 2, 4 and 8, publishers and other user 20, 22 and 24 involved in the publication process are granted access to any version of a KnowledgeArticle of the organization, i.e., tenant that has granted them access. Typically all other users 20, 22 and 24 may access only OKAs. This security is implemented in a plsql access check when users 20, 22 and 24 access database 44 initially. In this manner, a full history of changes for a single KnowledgeArticle is provided to publishers. To that end, KnowledgeBase operates in conjunction with a customizable user interface that includes multiple web pages, such a Find Article web page 150, that includes a plurality of data fields concerning different matters recorded in the KnowledgeBase, as well as a navigation panel 152. Navigation panel 152 facilitates access to KnowledgeArticles and webpage of the interface. The fields include information used to identify a group of data of a desired topic, referred to as a case. The case includes particularities that may be of interest to a user 20, 22 and 24 reviewing the case, as well as information directly related to the case. For example, the case may be an offer to provide additional services concerning a product, e.g., online customer relations management software, or information concerning problems that have arisen with use of a product and the like. The fields as shown are examples of fields that may be included. Typically, some of the data fields correspond with columns contained in KAT 63, as well as other information, as desired. For example, a case owner field 154, case number field 156, a contact name field 158, a contact phone number field 160, and a contact e-mail field 162. The information contained in the aforementioned fields facilitates identifying an individual that may be responsible for the case. A case origin field 164 may be included that identifies the manner in which a user of the KnowledgeBase was made aware of information that generated the case file. Other fields may be included, as well, such as an account name field 166, which identifies the name of the tenant that is the subject of the case number. A reason field 168 may include information concerning the reason when the case number was generated. Additionally, information concerning the date and time opened may be included in field 170. The product of the owner of architecture 12 that may be the subject of the case number may be identified in field 172, and the party that developed the product may be identified in field 174. The remaining fields are self-explanatory and optional, such as status field 176 that indicates if the case is new, pending, closed and the like, as well as subject field 178 that explains the subject of the case, i.e., a summary of what the case concerns. In addition there are several virtual buttons that allow different operations with respect to web page 150, e.g., edit button 180, delete button 182, close case button 184 and done button 186. Were a user 20, 22 and 24 desirous of acquiring information concerning any KnowledgeArticles present in database 44 corresponding to the case number shown in field 156, button 188 would be activated. Upon activation of button 188, web page 190, shown in FIG. 9, is rendered upon display 63, shown in FIG. 3.

Referring to FIGS. 4 and 9, web page 190 includes a title bar 192 reciting: Find Articles for Case: case_number”. A confirmation message region 194 would display a message that the case was saved were this a result of an action by user 20, 22 and 24 of saving in KnowledgeBase information concerning a new case. A case detail region 196 is also displayed upon web page 190 that is a style expected by use 20, 22 and 24 indicates the information contained in region 196. The information contained therein is a case number link 198, status information 200, subject information 202, contact name link 204 and account name link 206, which include the same information as fields 156, 176, 178, 158 and 166, respectively. Case number link 198 links to an additional web page (not shown) that provides more detailed information, as does contact name link 194 and account name link 196.

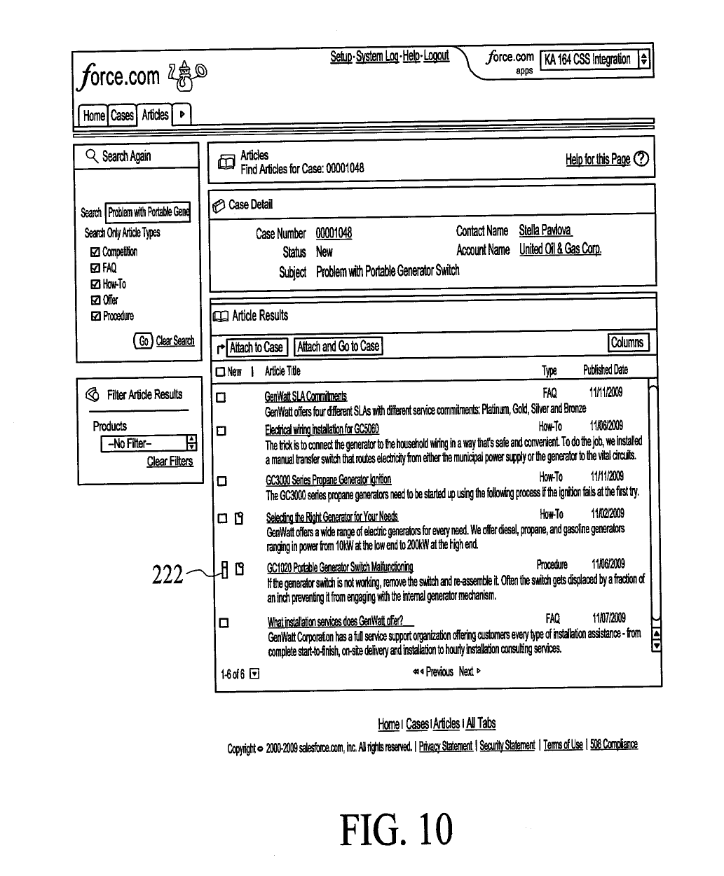

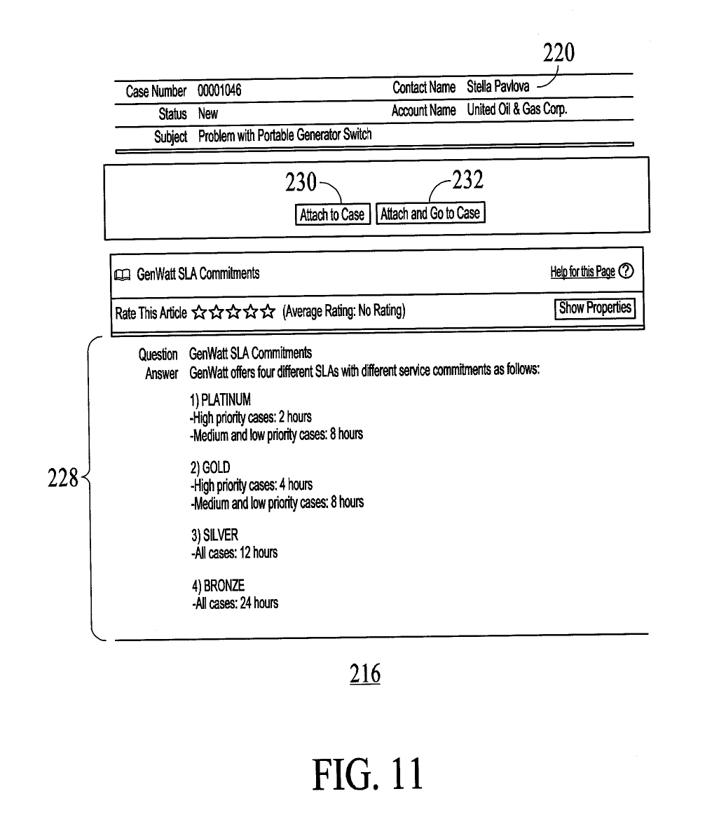

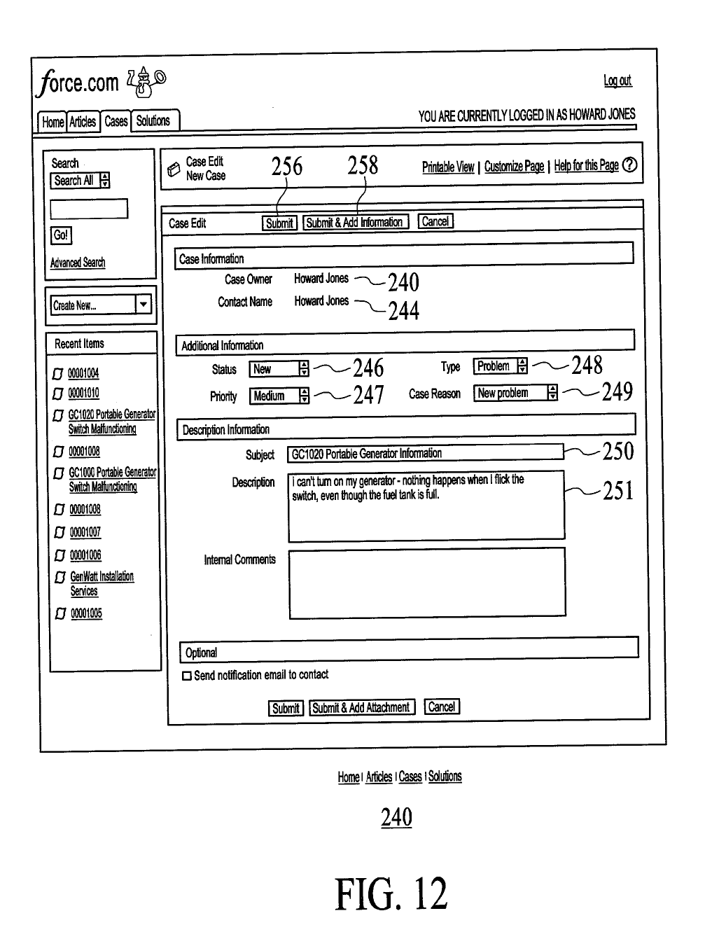

Information concerning KnowledgeArticles is recited in a section 208 of web page 190 entitled “Article Results”. A link 210 and a short abstract 212 corresponds to each KnowledgeArticle identified in section 208. Adjacent to each link 210 is a check box 214. Abstract 212 consists of about two rows of characters in superimposition with other metadata to inform a user 20, 22 and 24 as to the contents contained in the corresponding KnowledgeArticle. Activating the link 210 opens an Article Window 2116, discussed more fully below with respect to FIG. 11. Referring again to FIG. 9, also included in section 208 are two virtual buttons 218 and 220 entitled “Attach to Case” and “Attach and Go to Case”, respectively. Activating “Attach to Case” button 218 associates (attaches) the KnowledgeArticles corresponding to the link 210 adjacent to the box with the case number identified and having a check in check box 214. Articles associated with the case number identified in case number link 198 have an icon adjacent thereto in the shape of a paper clip 222, shown in FIG. 10. Referring again to FIG. 9, Activating “Attach and Go to Case” button 220 attaches the checked articles to the case and then loads web page 150. It should be understood that both “Attach to Case” button 218 and “Attach and Go to Case” button 220 are deactivated unless at least checkbox 214 is checked.

Also included on web page 190 is a data entry box 224 in which a user 20, 22 and 24 may introduce a search query to access database 44 and obtain desired cases and/or KnowledgeArticles. Along those lines, for a particular case number, the KnowledgeArticles retrieved that are associated therewith may be filtered, using data entry box 224, entitled “Filter Article Results”.

Referring to FIGS. 4 and 11, Article Window 216 includes a context bar 226 that includes the same information as region 196 to indicate to user 20, 22 and 24 the context of suggested articles for the case identified. Were the KnowledgeArticle sufficiently long to require scrolling, a scrollbar (not shown) would reach the top of an article section 228 in which the content of the KnowledgeArticle is rendered. Context bar 226 does not scroll. It is desired that context bar 226 be displayed only if the KnowledgeArticle is not already attached to the case. Otherwise nothing is displayed above section 228. Also present on Article Window 216 is an “Attach to Case” virtual button 230 and an “Attach and Go to Case” virtual button 232 that perform the same functions as virtual buttons 218 and 220, respectively. It is desired to update web page 150 concurrently with attaching articles to a case so that current article states in the article results are maintained.

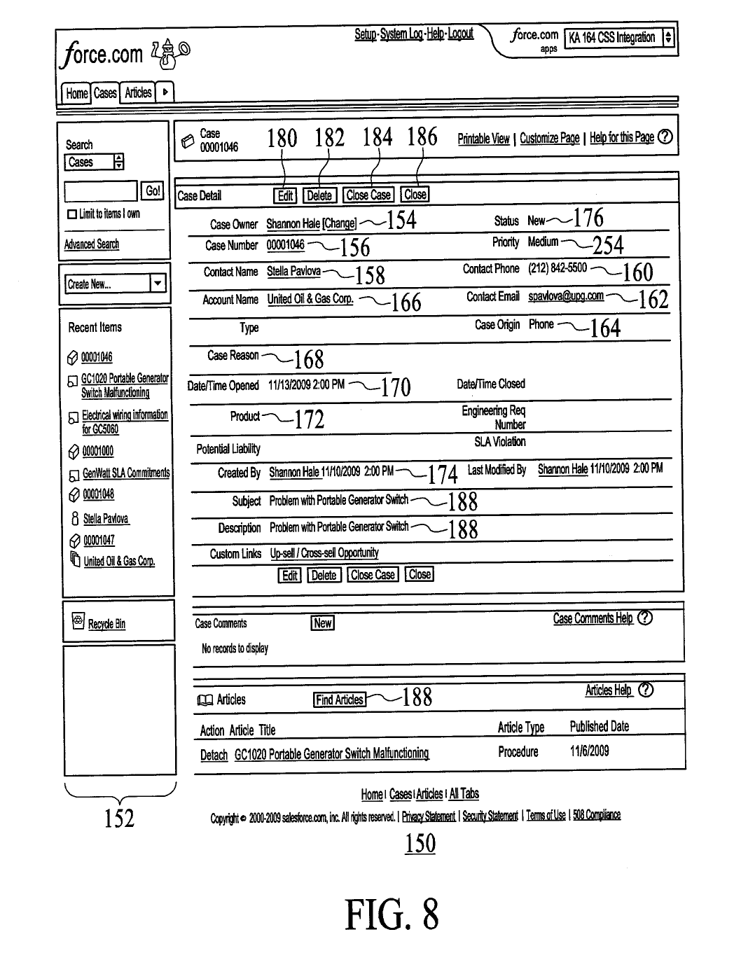

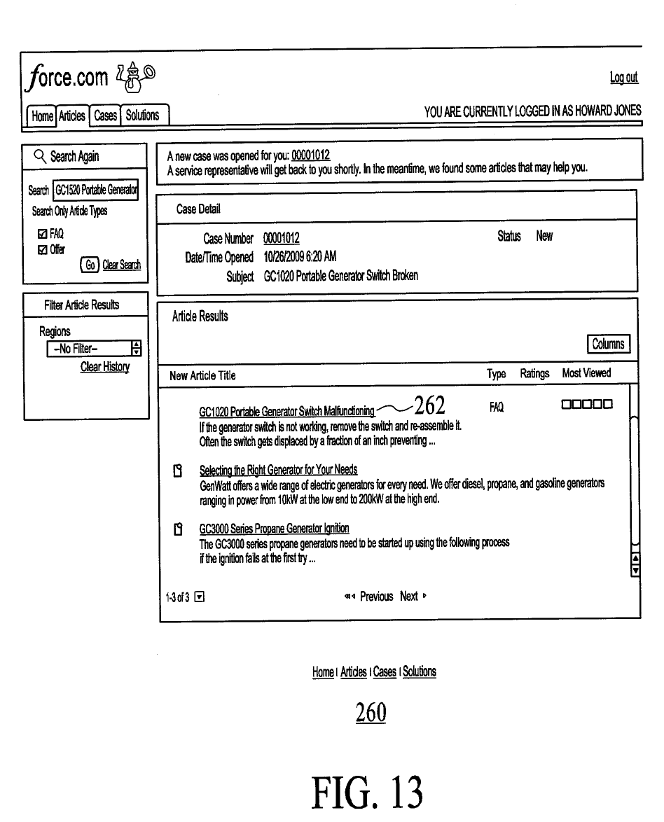

Referring to FIGS. 4 and 12, to include information concerning a new case in the KnowledgeBase, web page 240 is rendered on display 63. Web page 240 includes several information fields 242 and 244, as well as drop down menus (DDMs) 246-249 and two data entry fields (DEFs) 250 and 251. Information fields 242 and 244 are auto-populated based upon the identity of user 20, 22 and 24 accessing KnowledgeBase and would include the same information as recited in information fields 154 and 156, shown in FIG. 8. It should be understood, however, that other user's 20, 22 and 24 may be included herein at the desire of the case owner identified in information field 242. DDMs 246 and 247, shown in FIG. 12, have information recited therein that is displayed in information fields 176 and 254, shown in FIG. 8. Referring again to FIGS. 4 and 12, DDM 248 and 249. DEF 249 receives input from user 20, 22 and 24 that is recited in information field 178 of FIG. 8. Referring again to FIG. 12, DEM 251 receives input from user 20, 22 and 24 that is recited in information field 255 of FIG. 8. Also present on web page 240 is a “Submit” virtual button 256 and “Submit and Add” virtual button 258, shown in FIG. 12. Activating the Submit button 256 renders webpage on display 63, and activating Submit and Add button 258 renders webpage 216 on display 63 and then webpage 260, shown in FIG. 13.

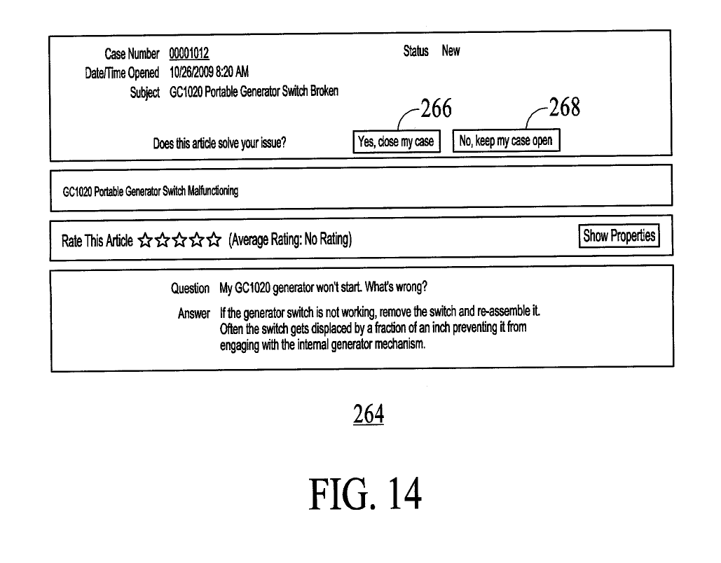

Referring to FIGS. 9, 13 and 14, webpage 260 is substantially identical to web page 190, excepting that section 192 is omitted and to attach articles to the open case by user 20, 22 and 24 activating an article link 262. Upon activation of one of the article links, webpage 264 is rendered upon display 63. Web page 264 is substantially identical to webpage 216, excepting that it includes two virtual buttons 266 and 268 that prompt user 20, 22 and 24 to close the case if the article is desired. Virtual button 266 entitled “Yes, close my case” attaches the articles to the case and takes the user to the standard Close Case form, e.g., webpage 150 upon which “Close Case” virtual button 184 is found. Activating virtual button 266 enters any closing comments entered in any of the previous webpages. Activating virtual button 268 renders webpage 260 on display.

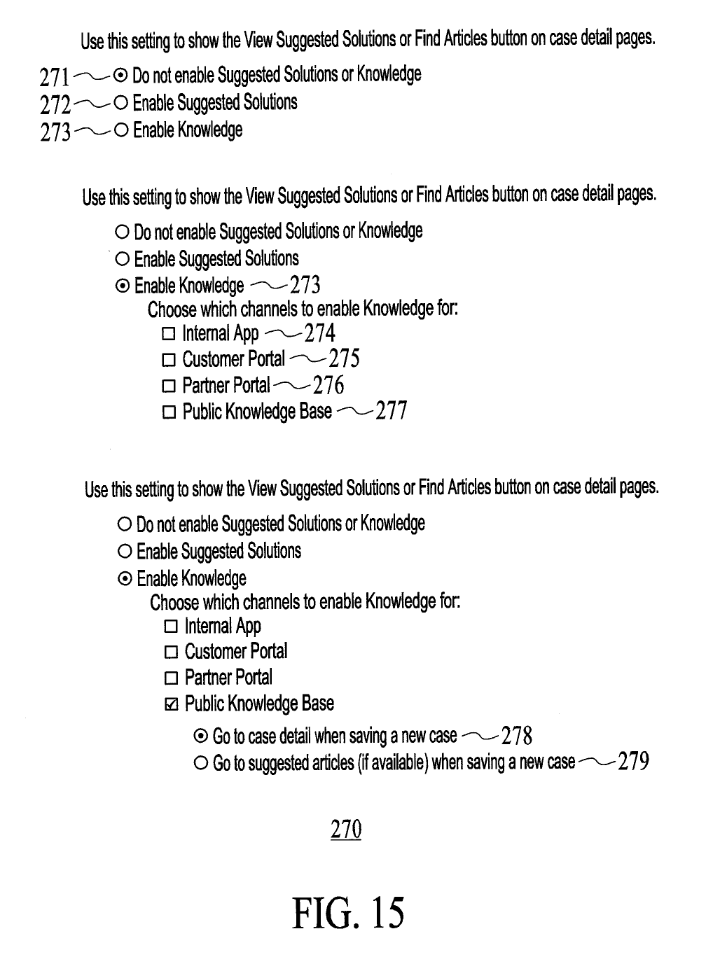

Referring to FIGS. 4 and 15, it should be understood that interface is entirely customizable by tenant or authorized users 20, 22 and 24 of tenant, e.g., a publisher. To that end, a Knowledge Support Settings (KSS) webpage 270 may be rendered on display 63. KSS webpage 270 has a plurality of radial buttons 271, 272 and 273. Associated with each of the radial buttons may be additional option selections for information perceivable by user 20, 22 and 24 of Knowledgebase. For example radial button 271 would preclude enabling suggestion solutions or Knowledge from being perceivable to a user 20, 22 and 24, e.g., web pages 240 and 264 would not be rendered upon display 63. With respect to radial buttons 272 and 273, additional settings that are available are hidden until the radial button 272 or 213 is selected. For example, selecting radial button 273 provides multiple selections 274, 275, 276 and 277, each of which may be activated by placing a check in a check box adjacent thereto. Selecting one of 274, 275, 276 and 277 may expose additional selection options, shown by radial buttons 278 and 219 that are exposed upon selecting 217. It should be understood that the selections provided are examples and that virtually any level of customization may be provided. KSS webpage 270 is accessible through navigation panel 152, of web page 150, shown in FIG. 8.

Almost all access to the knowledge base takes a single slice through the versions. Usually it's the online slice, except when a publisher is searching through the draft workspace. We will apply a filter during query and keyword search to ensure we use the right slice according to user and request context.

The Computer code for operating and configuring network 10 to intercommunicate and to process web pages, applications and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.). Therefore, the scope of the appended claims should be accorded the broadest interpretation so as to encompass all such modifications and similar arrangements.

1. A computer implemented method of managing a knowledge base stored in a multi-tenant architecture, said method comprising:
storing information corresponding to a plurality of KnowledgeArticles amongst a plurality of tables, with information in a first of said plurality of tables including data corresponding information contained in an online version of said KnowledgeArticles and data related to changes to said KnowledgeArticles, with information contained in a second table comprising a subset of said data in said one of said plurality of tables independent of said data related to changes;
recording changes in said second table in response to changes made to the data in said first table; and
restricting access to information in said one of said plurality of tables to users having write access to said KnowledgeArticles.

2. The method as recited in claim 1 wherein information contained in said one of said plurality of tables includes categories of custom data fields common to all KnowledgeArticles corresponding to information in said one of said plurality of tables.

3. The method as recited in claim 1 further including data in said information associating a publication status with each of said KnowledgeArticles selected from a set of publication statuses consisting essentially of online, draft and archived, with users having read access to said knowledge base having access to KnowledgeArticles associated with said online status.

4. The method as recited in claim 1 wherein storing further includes providing data in said information associating a publication status with each of said KnowledgeArticles, with said publication status being selected from a set consisting essentially of online, draft and archived, with access to KnowledgeArticles associated with said draft status being restricted to users having said write access.

5. The method as recited in claim 1 wherein storing further includes providing data in said information associating a publication status with each of said KnowledgeArticles, with said publication status being selected from a set consisting essentially of online, draft and archived, with two of said KnowledgeArticles having associated therewith common content and one of which has an online status associated therewith and a second having a draft status associated therewith, with access to said second KnowledgeArticle being restricted to users having write access to said knowledge base.

6. The method as recited in claim 1 wherein storing further includes providing data in said information associating a publication status with each of said KnowledgeArticles, with said publication status being selected from a set consisting essentially of online, draft and archived, with two of said KnowledgeArticles having associated therewith common content and one of which has said online status associated therewith and a second having said draft status associated therewith, with access to said second KnowledgeArticle being restricted to users having write access to said knowledge base.

7. The method as recited in claim 1 wherein storing further includes providing data in said information associating a publication status with each of said KnowledgeArticles, with said publication status being selected from a set consisting essentially of online, draft and archived, with two of said KnowledgeArticles having associated therewith common content and first of which has said online status associated therewith and a second having said draft status associated therewith, further including modify content associated with said first KnowledgeArticle by modifying content associated with said second KnowledgeArticle, defining a modified KnowledgeArticle and associating an on-line status with said modified KnowledgeArticle, wherein said first KnowledgeArticle is deleted in response to said modified KnowledgeArticle having an on-line status corresponding thereto.

8. The method as recited in claim 1 wherein restricting further includes allowing access to a subset of said users having write access to modify language of KnowledgeArticles while maintaining constant content associated therewith.

9. The method as recited in claim 1 further including rendering upon a computer of a user accessing said KnowledgeArticles a user interface, with a configuration of said user interface being dependent upon said information corresponding to said KnowledgeArticles.

10. A computer product of the type comprising a computer readable medium that contains a program of managing a knowledge base stored in a multi-tenant architecture, comprising:
computer code to store information corresponding to a plurality of KnowledgeArticles amongst a plurality of tables, with information in a first of said plurality of tables including data corresponding to an online version of said KnowledgeArticles and data related to changes to said KnowledgeArticles, with information contained in a second table comprising a subset of said data in said first table independent of said data related to changes;
computer code to record changes in said second table in response to changes made to said first table; and
computer code to restrict access to information in said one of said plurality of tables to users having write access to said KnowledgeArticles.

11. The computer program product as recited in claim 10 wherein said computer code to store further includes a subroutine to store said information in said one of said plurality of tables among categories of custom data fields common to all KnowledgeArticles.

12. The computer program product as recited in claim 10 further including code to associate a publication status of each of said KnowledgeArticles, with said publication status being selected from a set consisting essentially of online, draft and archived, with users having read access to said knowledge base having access to KnowledgeArticles associated with said online status.

13. The computer program product as recited in claim 10 further including code to associate a publication status with each of said KnowledgeArticles, with said publication status being selected from consisting essentially of online, draft and archived, with users having read access to said knowledge base having access to KnowledgeArticles associated with said online status.

14. The computer program product as recited in claim 8 further including code to associating with each of said information is said one of said plurality of tables and said second table includes a publication status of said KnowledgeArticles that is selected from a set consisting essentially of online, draft and archived, with access to KnowledgeArticles associated with said draft status being restricted to users having said write access.

15. The computer program product as recited in claim 10 wherein code to store further includes a sub-routine to provide data in said information associating a publication status with each of said KnowledgeArticles, with said publication status being selected from a set consisting essentially of online, draft and archived, with two of said KnowledgeArticles having associated therewith common content and one of which has an online status associated therewith and a second having a draft status associated therewith, with access to said second KnowledgeArticle being restricted to users having write access to said knowledge base.

16. The computer program product as recited in claim 10 wherein code to store further includes a sub-routine to provide data in said information associating a publication status with each of said KnowledgeArticles, with said publication status being selected from a set consisting essentially of online, draft and archived, with two of said KnowledgeArticles having associated therewith common content and one of which has said online status associated therewith and a second having said draft status associated therewith, with access to said second KnowledgeArticle being restricted to users having write access to said knowledge base.

17. The computer program product as recited in claim 10 wherein code to store further includes a sub-routine to provide data in said information associating a publication status with each of said KnowledgeArticles, with said publication status being selected from a set consisting essentially of online, draft and archived, with two of said KnowledgeArticles having associated therewith common content and first of which has said online status associated therewith and a second having said draft status associated therewith, further including modify content associated with said first KnowledgeArticle by modifying content associated with said second KnowledgeArticle, defining a modified KnowledgeArticle and associating an on-line status with said modified KnowledgeArticle, wherein said first KnowledgeArticle is deleted in response to said modified KnowledgeArticle having an on-line status corresponding thereto.

18. The computer program product as recited in claim 10 wherein code to restrict further includes a sub-routine to allow access to a subset of said users having write access to modify language of KnowledgeArticles while maintaining constant content associated therewith.

19. The computer program product as recited in claim 10 further including code to render upon a computer of a user accessing said KnowledgeArticles a user interface, with a configuration of said user interface being dependent upon said information corresponding to said KnowledgeArticles.

20. An apparatus to manage a knowledge base stored in a multi-tenant architecture, comprising:
a processor; and
one or more stored sequences of instructions which, when executed by the processor, cause the processor to carry out the steps of:
storing information corresponding to a plurality of KnowledgeArticles amongst a plurality of tables, with information in a first said plurality of tables including data corresponding to an online version of said KnowledgeArticles and data related to changes to said KnowledgeArticles, with information contained in a second table comprising a subset of said data in said one of said plurality of tables independent of said data related to changes;
recording changes in said second table in response to changes made to said first table; and
restricting access to information in said one of said plurality of tables to users having write access to said KnowledgeArticles.
